(19) United States
(12) Patent Application Publication
(10) Pub. No.: US 2022/0161172 A1
(43) Pub. Date: May 26, 2022

(54) NICKEL-BASED AIRBORNE PATHOGEN INHIBITOR AGAINST MICROBES, INCLUDING COVID-19

(71) Applicant: Arielle Svetlana Breuninger, Lancaster, PA (US)

(72) Inventor: Arielle Svetlana Breuninger, Lancaster, PA (US)

(21) Appl. No.: 17/314,220

(22) Filed: May 7, 2021

Related U.S. Application Data
(60) Provisional application No. 63/117,305, filed on Nov. 23, 2020.

(51) Int. Cl. B01D 39/20; B01D 46/00

(52) U.S. Cl. CPC B01D 39/2041; B01D 46/0028; B01D 46/0032; B01D 46/0021; B01D 2275/207; B01D 2239/0241; B01D 2239/0492; B01D 2273/30; B01D 2279/50; B01D 46/0035

(57) ABSTRACT

A filter matrix of nickel, nickel alloy, nickel-plated, nickel-oxide, nickel compound, or a combination thereof, surfaces, surface coatings, and impregnated surfaces that inhibit the growth of microbes that come in contact or in proximity to the surface of the filter. The nickel-based filter matrix reduces and/or eliminates microbes from air that flows over or through the filter. A fan or pressure differential can be used to blow or draw the fluid or air across the treated surfaces.

This application claims the benefit of U.S. Provisional Patent Application No. 63/117,305 filed Nov. 23, 2020 by the same inventor, which provisional patent application is hereby incorporated by reference as if repeated herein in its entirety, including the drawings.

### BACKGROUND

The present invention relates generally to methods and apparatuses for inhibiting pathogens, and more particularly to a method and apparatus for inhibiting the transmission of airborne pathogens.

Each day, interactions among humans result in the transmission of bacteria, viruses, fungi, and other microbes, some strains of which are the source for contagion. Numerous infectious diseases, such as COVID-19 (2019 novel coronavirus disease), MERS (Middle East respiratory syndrome), influenza, tuberculosis, pneumonia, and mycoplasma, are transferred through airborne mechanisms, and pose serious health and economic risks. In low-income countries, for example, lower respiratory infections are the leading cause of death. The Center for Disease Control also reports more than 2.8 million antibiotic-resistant infections in the U.S. annually, as well as 1.7 million healthcare associated infections (HAIs). HAIs alone result in an annual economic burden of $28 to $45 billion in the United States.

The present invention is therefore directed to the problem of developing a method and apparatus for inhibiting the transmission of airborne pathogens.

### SUMMARY OF THE INVENTION

The present invention solves these and other problems by providing an apparatus for filtering a fluid, such as air, with inner surfaces comprised of an anti-pathogenic material. The anti-pathogenic material can include one or more of the following: nickel, nickel-plated brass, brass, a nickel alloy, such as nickel alloy 400, a nickel-plated material, a nickel oxide material, a nickel compound, copper, copper-plated material, copper alloys, such as bronze and brass, and even wood, such as cherry wood, and combinations thereof. Nickel alloy 400 was used herein and is comprised of 63-70% Nickel, 28-34% Copper, 2.5% Iron, 2% Manganese, 0.5% Silicon, 0.3% Carbon and 0.024% Sulfur. Furthermore, the metallic surfaces can be optionally electrically or electrostatically charged with a constant or alternating charge to promote particle contact with the nickel-based filter. As used herein, the term “pathogen” includes microbes, microorganisms, bacteria, fungi, viruses and parasites.

According to one aspect of the present invention, an exemplary embodiment of an apparatus for filtering a fluid, including air, includes longitudinal fluid conductors with inner and exposed surfaces coated or embedded with certain nickel materials, such as nickel, a nickel alloy, a nickel-plated material, a nickel oxide material, a nickel compound, a nickel-plated brass material, and a combination thereof. Each longitudinal fluid conductor has a diameter between about 1 nanometer to about 10 centimeters, which can be arranged together to form larger composite sizes.

The apparatus may include additional longitudinal fluid conductors disposed downstream from other longitudinal fluid conductors. These additional longitudinal fluid conductors have the same type of nickel (or nickel coating or nickel embedding) on their inner surfaces (and all exposed surfaces) and similar diameters. This apparatus may include a fan blowing the fluid into (or a fan drawing the fluid out of) the first group of longitudinal conductors and then into (or out of) the second group of longitudinal conductors. Additionally, the apparatus may include a housing containing the longitudinal conductors. The housing may also be coated or embedded with the same nickel material. Optionally, each of the longitudinal fluid conductors may have an electric charge to attract pathogen and pathogen-carrying particles to come in contact with the coated or embedded surface.

In this embodiment and others, a fan may be placed on the back side of the filter, thereby drawing the fluid or air out. Alternatively, a pressure differential can be created by any of various natural or induced means, including a fan or blower on either side of the filter to provide the necessary fluid or air flow.

According to another aspect of the present invention, an exemplary embodiment of a filter matrix includes surfaces composed of one or more of the following: nickel, a nickel alloy, a nickel-plated material, a nickel-plated brass material, a nickel oxide material, a nickel compound, and a combination thereof. The filter matrix also includes a pressure differential or fan, drawing or blowing air over the surfaces (or a pressure differential drawing the air through the surfaces), whereby the interaction of the air and the surfaces inhibits growth of pathogens or microbes that come in contact or in proximity to these surfaces.

According to another aspect of the present invention, an exemplary embodiment of a method for filtering a fluid, such as air, includes forcing or drawing the fluid through one or more filter stages, wherein each of the filter stages has an input to receive the fluid and an output via which filtered fluid exits. The method further includes drawing or forcing the fluid over several surfaces inside each of the filter stages, wherein each of the surfaces is comprised of one or more of the following: nickel, a nickel alloy, a nickel-plated material, a nickel-plated brass material, a nickel oxide material, a nickel compound, and a combination thereof.

In this exemplary embodiment, the filter stage may include tubes having a circular cross-section, and each of the inner and/or outer surfaces of the tubes is comprised of one or more of the following: nickel, a nickel alloy, a nickel-plated material, a nickel oxide material, a nickel compound, and a combination thereof. The surfaces may be coated or embedded with these materials as well.

In this exemplary embodiment, the filter stage may include tubes arranged in a honeycomb-like pattern. In this instance, each of the tubes has a hexagonal or triangular cross-section, and each of the inner and/or outer surfaces of the tubes is comprised of one or more of the following: nickel, a nickel alloy, a nickel-plated material, a nickel oxide material, a nickel compound, and a combination thereof. The cross-sectional shape can be triangular, or any polygonal, rounded, or amorphous shape, as well as vary in cross-sectional area through the course of the filter matrix.

In this exemplary embodiment, the filter subcomponent tubular walls may be as thin as foil to improve airflow and microbe contact rate through the filter cross-sectional area. In this instance, the foil may be comprised of one or more of the following: nickel, a nickel alloy, a nickel-plated material, a nickel-plated brass material, a nickel oxide material, a nickel compound, and a combination thereof.

In this exemplary embodiment, the filter stage may include a maze structure, wherein the fluid is drawn through or forced to pass through multiple chambers inside the maze structure and thereby interact with the inner and/or outer surfaces inside the maze structure, and the inner and/or outer surfaces are comprised of one or more of the following: nickel, a nickel alloy, a nickel-plated material, a nickel oxide material, a nickel compound, and a combination thereof.

In this exemplary embodiment, the filter stage may include a radial baffle, wherein the fluid is drawn through or forced to pass through multiple chambers inside the radial baffle and thereby interact with a plurality of inner surfaces inside the radial baffle, and each of the plurality of inner surfaces is comprised of one of more of the following: nickel, a nickel alloy, a nickel-plated material, a nickel-plated brass material, a nickel oxide material, a nickel compound, and a combination thereof

In this exemplary embodiment, the filter stage may include a fiber filter having treated fibers, wherein each of the treated fibers is treated with one or more of the following: nickel, a nickel alloy, a nickel-plated material, a nickel-plated brass material, a nickel oxide material, a nickel compound, and a combination thereof.

In this exemplary embodiment, the filter stage may include a thread-based filter having treated threads, wherein the treated threads are treated with a coating or saturation of one or more of the following: nickel, a nickel alloy, a nickel-plated material, a nickel-plated brass material, a nickel oxide material, a nickel compound, and a combination thereof.

In this exemplary embodiment, the filter stage may include a wire-based filter having treated wires, wherein the treated wires are either comprised of and/or treated with one or more of the following: nickel, a nickel alloy, a nickel-plated material, a nickel-plated brass material, a nickel oxide material, a nickel compound, and a combination thereof. The treated wires may be formed in a fibrous-like mesh.

Alternatively, the filter stages may be disposed in a circular tube, and each of the filter stages may be formed in concentric circles inside the circular tube coupled together by several radii joined at a center of the concentric circles and projecting outward to the inner surface of the circular tube. The inner surface of the circular tube may be comprised of one or more of the following: nickel, a nickel alloy, a nickel-plated material, a nickel-plated brass material, a nickel oxide material, a nickel compound, and a combination thereof.

Alternatively, the filter stages may be disposed in a four-sided tube, and each of the filter stages are formed as parallel wires or intermeshed screens attached to the sides of the four-sided tube. The inner surface of the four-sided tube and/or the parallel wires or intermeshed screens may be comprised of one or more of the following: nickel, a nickel alloy, a nickel-plated material, a nickel-plated brass material, a nickel oxide material, a nickel compound, and a combination thereof.

Alternatively, the filter stages may be inside a canister through which the fluid passes. In this instance, the canister has balls or other three-dimensional shapes disposed inside, wherein an outer surface of each of the balls is comprised of one or more of the following: nickel, a nickel alloy, a nickel-plated material, a nickel-plated brass material, a nickel oxide material, a nickel compound, and a combination thereof. The balls may be lightly packed so that the balls become airborne when the fluid passes through the canister; or the balls may be densely packed so that the balls do not move or move only slightly when the fluid passes through the canister. The balls may have an electric charge to attract pathogen and pathogen-carrying particles to come in contact said balls.

The canister may have an inner surface made of one or more of the following: nickel, a nickel alloy, a nickel-plated material, a nickel-plated brass material, a nickel oxide material, a nickel compound, and a combination thereof.

Alternatively, the filter stage may be a metal embedded pleated filter, wherein the metal comprises one or more of the following: nickel, a nickel alloy, a nickel-plated material, a nickel-plated brass material, a nickel oxide material, a nickel compound, and a combination thereof.

Alternatively, the filter stage may be a metal embedded fiber filter, wherein the metal comprises one or more of the following: nickel, a nickel alloy, a nickel-plated material, a nickel-plated brass material, a nickel oxide material, a nickel compound, and a combination thereof.

Alternatively, the filter stage may be a metal plated electrostatic filter, wherein the metal comprises one or more of the following: nickel, a nickel alloy, a nickel-plated material, a nickel-plated brass material, a nickel oxide material, a nickel compound, and a combination thereof.

According to another aspect of the present invention, an apparatus for filtering a fluid includes an enclosed canister. In this instance, a fluid input may be disposed at the bottom of the canister to receive the fluid to be filtered, and a fluid output may be disposed at a top of the canister to output the filtered fluid. Depending upon the use, the top and bottom may be inverted. Inside the canister is a scrubbing fluid recirculation section to receive the fluid from air input and disposed at the bottom of the canister. A plate is disposed above the scrubbing fluid recirculation section, which holds metal coated surface media. Scrubbing fluid dispensers are disposed above the plate and dispense scrubbing fluid onto the metal coated surface media. A mist eliminator may or may not be disposed above the scrubbing fluid dispensers and below the fluid output, wherein the metal comprises one or more of the following: nickel, a nickel alloy, a nickel-plated material, a nickel oxide material, a nickel compound, and a combination thereof.

According to another aspect of the present invention, an apparatus for filtering pathogens includes a plurality of surfaces composed of at least one material selected from the group consisting of: nickel, a nickel alloy, a nickel-plated material, a nickel-plated brass material, a nickel oxide material, a nickel compound, bronze, brass, and cherry wood; and a pressure differential drawing the air over the plurality of surfaces, whereby the interaction of the air and the plurality of surfaces inhibits growth of pathogens that come in contact or in proximity to the plurality of surfaces.

In this embodiment and the ones above, the pathogens includes at least one selected from the group consisting of: microbes, microorganisms, bacteria, fungi, viruses and parasites.

In this embodiment and the ones above, each of the surfaces may have an electric charge to attract pathogen and pathogen-carrying particles to come in contact said each of the plurality of surfaces.

### BRIEF DESCRIPTION OF THE DRAWINGS

Various other objects, features, and attendant advantages of the present invention will become fully appreciated as the same becomes better understood when considered in conjunction with the accompanying drawings.

FIG. 1A depicts an exemplary embodiment of a circular tubular filter design employing one or more filter stages according to one aspect of the present invention.

FIG. 1B depicts an exemplary embodiment of a honeycomb-like tubular filter design employing one or more filter stages according to another aspect of the present invention.

FIG. 1 C depicts an exemplary embodiment of a tubular filter design employing one or more filter stages according to another aspect of the present invention, wherein the tubular filter has a triangular cross-section.

FIG. 2A depicts another exemplary embodiment of a tubular nickel filter design employing one or more filter stages according to still another aspect of the present invention.

FIGS. 2B-C depict an exemplary embodiment of a radial baffle nickel filter design employing one or more filter stages according to yet another aspect of the present invention.

FIG. 3A depicts an exemplary embodiment of a nickel coated and/or embedded fiber filter according to still another aspect of the present invention.

FIG. 3B depicts an exemplary embodiment of a radial nickel wire filter employing one or more separate filter stages according to yet another aspect of the present invention.

FIG. 3C depicts an exemplary embodiment of a linear nickel wire filter employing one or more separate filter stages according to still another aspect of the present invention.

FIG. 4A depicts an exemplary embodiment of a canister nickel filter employing airborne nickel balls according to yet another aspect of the present invention.

FIG. 4B depicts an exemplary embodiment of a canister nickel filter employing static or loosely packed nickel balls according to still another aspect of the present invention.

FIG. 5A depicts an exemplary embodiment of a nickel surface media scrubber filter employing airborne nickel balls according to yet another aspect of the present invention.

FIG. 6A depicts an exemplary embodiment of a nickel-embedded pleated filter paper-like medium according to still another aspect of the present invention.

FIG. 6B depicts an exemplary embodiment of a nickel-embedded coarse-fiber filter according to yet another aspect of the present invention.

FIG. 6C depicts an exemplary embodiment of a nickel-plated electrostatic filter according to still another aspect of the present invention.

FIG. 7 shows an exemplary embodiment and functional prototype of a circular tubular filter design as shown in FIG. 1A.

FIG. 8A depicts a nickel electroplating process incorporated to plate copper tubes used as subcomponents in several embodiments of the present invention.

FIG. 8B depicts a test sample on a tryptic soy agar plate after an incubation period to grow bacteria.

FIG. 8C depicts a portion of a functional prototype of the nickel honeycomb-like filter configuration of the Circular Tubular Filter Design further described in FIG. 1A.

FIG. 9 depicts a chart showing the antimicrobial properties of nickel-plated brass versus twelve other materials according to one aspect of the present invention.

FIG. 10 depicts a chart showing that even when nickel plating thickness is reduced from 13 μm to 3 μm, nickel-plated brass still inhibits E. coli bacterial growth.

FIG. 11 depicts copper and nickel-plated copper filter subcomponents used in the exemplary embodiment of the present invention depicted in FIG. 7.

FIG. 12A depicts an overview of nickel-plating calculations for current density and reaction time to achieve desired nickel plating thickness used in the nickel electroplating process of various embodiments of the present invention.

FIG. 12B depicts a chart showing nickel plate thickness over time at a representative electroplating solution current density (1.09 A/dm²) for the nickel electroplating process of various embodiments of the present invention.

FIGS. 12C-E depicts three stages of the electroplating process used in testing the embodiments of the present invention, including the cutting of copper substrate tubing, lowering of the electroplating jig into the nickel-ion solution, and a view of the rectifier used to control the voltage and current of the bench-scale electroplating process of various embodiments of the present invention.

FIG. 13A depicts the primary nickel electroplating process components used in conducting experiments of the present invention.

FIG. 13B depicts the primary microbe testing chamber components used in conducting experiments using a prototype of the present invention.

FIGS. 13C-H depict pictures of the components of FIGS. 13A-B.

FIG. 13C is a layout of most of the parts utilized to build a prototype of various embodiments of the present invention.

FIG. 13D is a process developed for nickel electroplating subcomponents of a prototype filter used in various embodiments of the present invention.

FIG. 13E is a representation of copper and nickel filter subcomponents used in various embodiments of the present invention.

FIG. 13F shows the ambient-air intakes of three prototype filter test chambers used in various embodiments of the present invention.

FIG. 13G shows an illustrative agar plate used to measure bacteria concentrations within a prototype device used in various embodiments of this present invention.

FIG. 13H shows the incubation chamber used to culture bacteria from ambient air test samples.

FIG. 14A depicts the summary procedure for the nickel electroplating subcomponents of one embodiment of the present invention.

FIGS. 14B-G depict pictures of the nickel electroplating process of FIG. 14A.

FIG. 14B depicts the cutting of the copper tubing used to make the filter subcomponent substrate in a prototype device used in various embodiments of this present invention.

FIG. 14C depicts illustrative voltage and current settings used to plate nickel onto filter subcomponents in various embodiments of this present invention.

FIG. 14D depicts the electroplating process used in various embodiments of this present invention.

FIG. 14E depicts filter subcomponents prior to nickel electroplating used in various embodiments of this present invention.

FIG. 14F depicts filter subcomponents after nickel electroplating used in various embodiments of this present invention.

FIG. 14G depicts copper and nickel-plated subcomponents used to build the honeycomb filter used in various embodiments of this present invention.

FIG. 15A depicts the summary procedure for building and operating the microbe testing chamber for experiments used in the present invention.

FIGS. 15B-G depict pictures of the process of FIG. 15A.

FIG. 16 depicts a chart of bacteria growth for an exemplary embodiment of a nickel filter of certain specifications versus no filter for five separate trials.

FIG. 17 depicts a chart of statistical analysis of test data from experiments of an exemplary embodiment of the present invention.

FIGS. 18A-C depict pictures of bacteria growth for unfiltered air, copper filtration, and nickel filtration, respectively, with each having increased average resistance to bacteria growth from experiments of an exemplary embodiment of a functional prototype of the present invention.

FIG. 19 depicts an exemplary embodiment of a corrugated nickel-plated filter according to still another aspect of the present invention.

### DETAILED DESCRIPTION

The effectiveness of different metals at resisting E. coli bacteria growth was tested; and it was discovered that nickel-plated copper significantly outperformed the other materials tested. Further investigation suggested that antimicrobial properties of nickel do not diminish at reduced nickel-plating thicknesses. Demonstrations indicated that antimicrobial properties of nickel can be extended to reduce bacteria in ambient air.

Applications for the various embodiments of the present invention include commercial (supermarkets, shopping malls, retail outlets, markets, service centers, restaurants, etc.), residential (homes, apartments, condominiums, housing communities, hotels, resorts, etc.), transportation (buses, trains, airplanes, cruise ships, transportation hubs, etc.), work/school (schools, universities, trade institutes, office buildings, government buildings, manufacturing sites, places of worship, etc.), medical (hospitals, surgery centers, doctor offices, urgent care facilities, medical facilities, etc.), and recreational (convention centers, theaters, concerts, cinemas, sporting events, amusement parks, etc.).

An exemplary embodiment of an air filtration device was built by first nickel electroplating 118 copper tubes with a length of 30 mm and an outer diameter of 6 mm. The nickel-plated tubes were then arranged in a honeycomb configuration in an enclosed chamber where ambient air was passed through the nickel filter to agar plates.

After 24 hours of incubation, results showed that filtering ambient air through nickel-plated copper reduced bacterial growth by 43%. This research suggests that if nickel-plated copper filters were incorporated into heating, ventilation, and air conditioning systems of public spaces—or as a stand-alone air filtration device—there could be both a significant reduction in sickness and death, as well as a global economic benefit in the order of several billions of dollars annually through the reduction of ambient air as a source of contagion.

There are multiple ways to implement the present invention. Described herein is an arrangement of nickel, nickel alloy, nickel-plated, and nickel oxide tubes arranged in a honeycomb-like design, which airflow passing from one end to the other, along the interior and exterior surface of the tube arrangement. The tubes themselves could consist of a cross-sectional profile that is circular, oval, hexagonal, or any other polygon or asymmetrical shape, such as a teardrop.

Airflow can also be regulated to change the fluid dynamic nature of the air as it contacts the surface of the honeycomb filter design, from laminar to non-laminar turbulent flow. The advantage of non-laminar flow is that it increases the contact of the air particles and microbes into the metallic surface of the filter as the air passes from one end to the other end of the filter device. The degree of turbulence from non-laminar airflow needs to be regulated so as not to create too much air resistance and block the flow of air through the metal filter device.

In addition to the honeycomb-like filter design, the nickel-based filter can be designed as a series of baffles, channels, or any arrangement of nickel-based surfaces through which flows the air, with each baffle or surface in the airflow pathway inducing more contact between the nickel-based surface and the microbes transported by the fluid. A mechanism of effectiveness in the nickel-based or copper-based air filter is that as a microbe—defined as a bacterium, virus, fungus, etc. comes in contact with the nickel-based or copper-based surface, the surface contact inhibits the growth and even destroys the bacterium, virus, or other type of microbe.

Another filter design is to impregnate traditional air filter media with fine particles of nickel, nickel alloy, nickel oxide, or nickel plated material. As the air flows past the nickel-based surfaces, microbes in the air become inactive or are diminished in their ability to propagate.

The use of the present invention is not limited to filtering air for microbes in commercial, residential, industrial, governmental, and other buildings, open spaces, or other public areas. The present invention could be applied to other areas: (i) Laboratory or clean room settings in which the elimination or absence of microbes is a requirement or objective; (ii) Healthcare and patient care facilities where the elimination or reduction of microbes from the air or from surfaces is an objective; (iii) Automotive and other transportation applications where the cabin air is to be free or of reduced levels of microbes; (iv) Aerospace applications where the cabin air is to be free or of reduced levels of microbes, which includes commercial aircraft, private aviation, or spacecraft; and (v) Personal filtration devises, where a user aspirates air through a nickel-based filter with the intent of removing or reducing microbes.

### Exemplary Embodiments

Air and fluid filters implementing the aforementioned inventions can be built in a variety of structures. The present invention provides differing classes of filter designs based on surfaces comprised of nickel, nickel-plated substrate (such as copper or brass), nickel alloy, or nickel compounds (such as nickel oxide or particles or fibers thereof) coating, adhered to, imbedded or impregnated within, or intermixed with other material such as nickel-based particles adhered to or embedded within polymer fibers.

Circular-Tubular Packed Design Nickel Filter

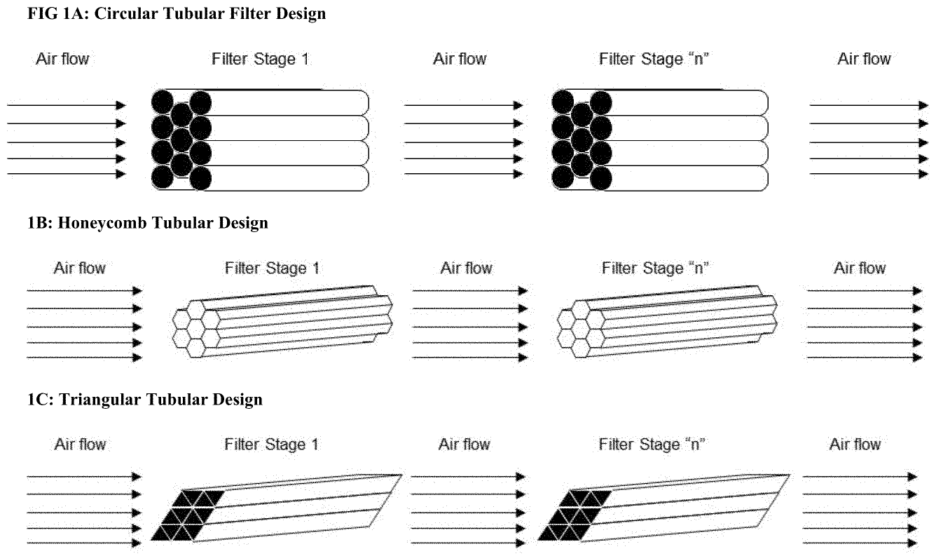

Turning to FIG. 1A, shown therein is an exemplary embodiment of circular tubular filter design according to one aspect of the present invention.

Composition: Anti-Microbial Nickel

The filter is composed of nickel, nickel plated substrate (such as copper or brass), nickel alloy, nickel compounds such as nickel oxide or particles or fibers thereof imbedded, impregnated, adhered, or intermixed with other material, such as nickel-based particles adhered to polymer fibers.

Turning to FIG. 1B, shown therein is an exemplary embodiment of honeycomb tubular filter design according to another aspect of the present invention. While this embodiment shows a hexagonal cross-section, other shapes and cross-sections are also within the scope of the present invention, such as shown in FIG. 1C, which employs a triangular cross-section.

Walls of honeycomb-like stacked components can be plated or coated with varying thicknesses of nickel, nickel alloy, or nickel oxide as shown in FIG. 1B. Walls of filter can be solid nickel or nickel alloy. Inner and/or outer walls can be coated with nickel, either through plating, vapor deposition, sputtering, spraying, brushing, dipping, painting, powdering, baking or any other method of coating. Walls can be made of a metal other than nickel or of any material which serves as a substrate for the nickel-based coating. Walls can be impregnated with elemental nickel or nickel alloy, such as a ceramic impregnated with nickel. Walls can be made from pipe, channel, conduit or flexible pipe, channel, conduit, or woven tubing or channel, including fabric or metallic chain or fabric coated.

Tubular Geometry

The cross-sectional shape can be circular, oval, triangular, hexagonal, or any other polygon, non-polygon, or amorphous shape, such as tear-drop, crescent, star-shaped, etc. The tube can vary in length and cross-sectional area, depending on airflow requirements, air-pressure limitations, and air-to-filter-surface contact duration (average amount of time a microbe or air particle remains in contact with the active (nickel) portion of the filter matrix) or contact rate (average number of times a microbe or air particle touches the surface from input to output from filter). Stacking configuration of tubes can vary, utilizing both the inner and outer surface as active contact surfaces. Filters can be placed in parallel or in series configuration in a virtually unlimited number, depending on the nature of the application. Filters can also be as thin as a fabric sheet used for making filtration masks. Tube inner diameter can vary from ˜1 nanometer to ˜10 centimeters.

Tubular Properties

Tube can be rigid, flexible, made from solid pipe (e.g. extruded, cast, etc.), corrugated, or fabricated in some other sectional way. Tubes can be singularly hollow, patterned hollow, porous or of solid composition and constructed in a fabric-like way in woven sheets, such as for use as filter material in filtration masks or respirators, filtration garments, or any other barrier to inhibit the passage of microbes. Fabric could be of metallic nickel or nickel-compound construction or coated or embedded natural fibers (e.g. cotton, wool, etc.) or synthetic fibers (e.g. polyester, polypropylene, nylon, acrylic, fiberglass, rock wool, mineral wool, etc.). Tubes can be grouped together in any number and any configuration. Tubes can be perforated with holes, slits, etc. Tube inner and outer surface can be smooth, rough, channeled, ribbed, spiraled, grooved, tapered, multi-stage tapered. Tubes can be straight, curved, coiled, elbowed, undulated, or shaped into any variety of directions to optimize air flow and particle contact with the antimicrobial active portion of the surface.

Air Flow

With fan or blower at inlet or outlet or midstream, or pressure differential from input to output to induce air flow naturally or mechanically. Air flow speed and volume controlled to optimize microbe contact with surface from laminar flow and turbulent flow.

Housing

Nickel filters can come in segments or racks staged in parallel or series from 1 to “n” in number. Filters and housing can be disposable/replaceable, or cleanable/washable and reusable.

Nickel Baffle Filter

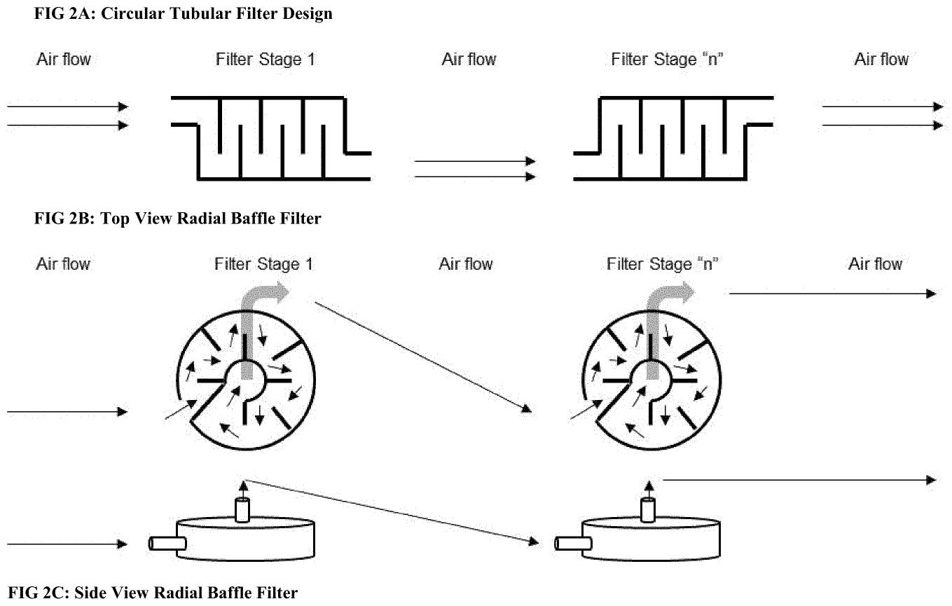

Shown in FIGS. 2A and 2B are exemplary embodiments of nickel baffle filters according to another aspect of the present invention.

Composition: Anti-Microbial Nickel

Filter made of nickel, nickel plated substrate (such as copper or brass), nickel alloy, nickel compounds such as nickel oxide or particles or fibers thereof imbedded, impregnated, adhered, or intermixed with other material, such as nickel-based particles adhered to polymer fibers. Walls of configured tube components can be plated, coated, impregnated, or embedded with varying thicknesses of nickel, nickel alloy, or nickel compound. Walls of filter can be solid nickel or nickel alloy. Inner and/or outer walls can be coated with nickel, either through plating, vapor deposition, sputtering, spraying, brushing, dipping, painting, powdering, baking or any other method of coating. Walls and baffles can be made of a metal other than nickel or of any material which serves as a substrate for the nickel-based coating. Walls and baffles can be impregnated with elemental nickel or nickel alloy, such as a ceramic impregnated with nickel. Walls and baffles can be made from pipe, ducting, channel, conduit or flexible pipe, channel, conduit, or woven tubing or channel, including fabric or metallic chain or fabric coated.

Filter Geometry

Fluid such as air enters into a nickel-coated chamber and passes through a series of baffles that are configured to optimize microbe contact frequency and duration within the chamber before exiting. Baffle can be configured in a linear or radial pattern. Baffles can be perforated, angled, curved in any plane, and movable/rotatable.

Air Flow

With fan or blower at inlet or outlet or midstream, or pressure differential from other means, input to output, to induce air flow. Air flow speed and volume controlled to optimize particle contact with surface from laminar flow and turbulent flow.

Housing

Nickel filters can come in segments or racks staged in parallel or series from 1 to “n” in number (See FIGS. 2A and 2B). Filters and housing can be disposable/replaceable, or cleanable/washable and reusable.

Nickel Wire/Fiber Filter

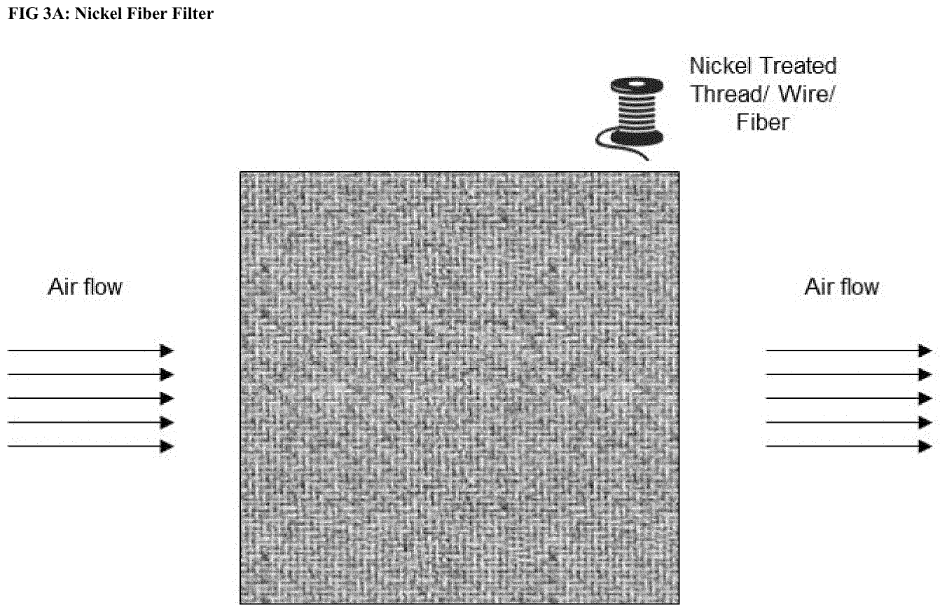

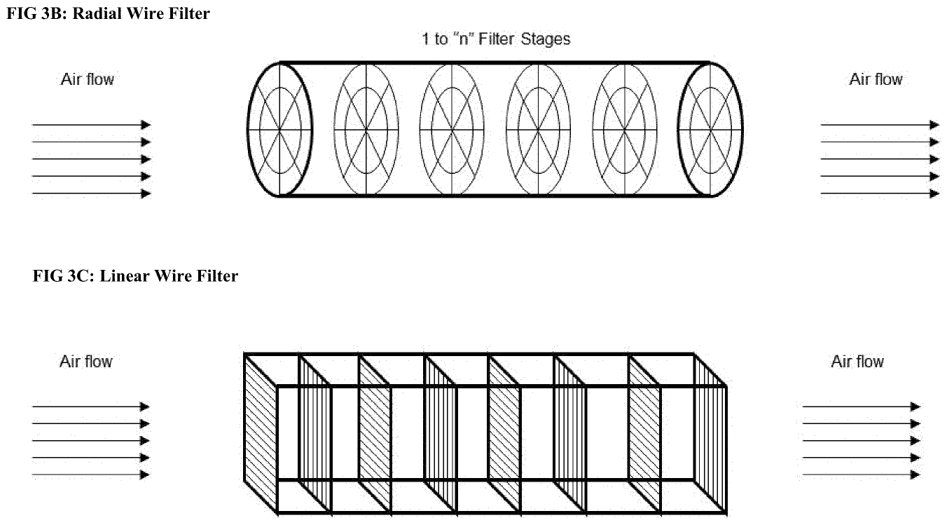

Shown in FIGS. 3A-C are exemplary embodiments of nickel-based fiber filters according to another aspect of the present invention.

Composition: Anti-Microbial Nickel

Filter and filter material made from layers of wire or weave of nickel-based fiber (with varying cross-sectional shape, e.g. round, square, triangular, grooved, etc.) of nickel, nickel plated substrate (such as copper or brass), nickel alloy, nickel-based-compound coatings, such as nickel oxide, or particles or fibers thereof imbedded, impregnated, adhered, or intermixed with other material, such as nickel-based particles adhered to synthetic or natural fibers (see FIGS. 3A-3C).

Extruded or spun nickel, nickel alloy, nickel plated, nickel-compound, or nickel-coated fibers are woven into a fabric either entirely of nickel, nickel alloy, nickel plated, or nickel coated fibers. The nickel fibers can also be interwoven with other natural or synthetic fibers to improve overall fabric performance.

Nickel particles can also be coated, embedded, or saturated in varying amounts to or within natural (e.g. cotton or wool) and synthetic (e.g. polyester, polypropylene, nylon, acrylic, fiberglass, rock wool, mineral wool, etc.) fibers, such that growth from microbes coming in contact with or in proximity to the nickel-based particles adhered to the fiber will be inhibited.

Canister Nickel Filter

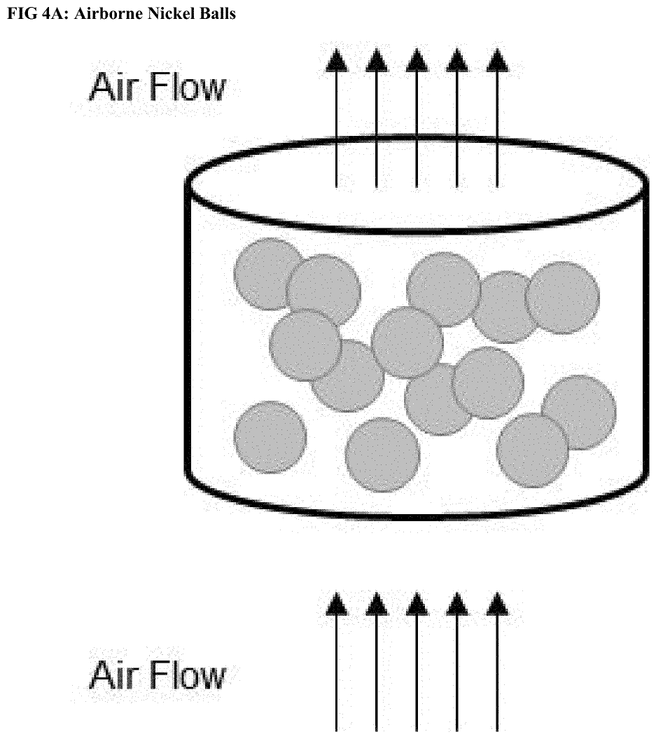

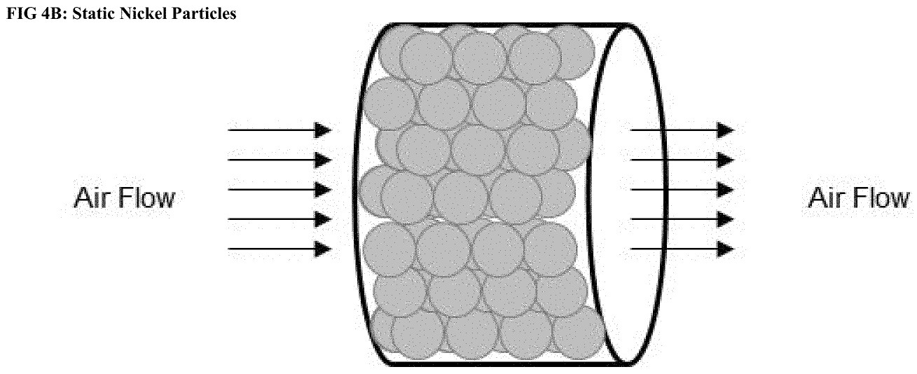

Shown in FIGS. 4A and 4B are exemplary embodiments of canister nickel filters according to another aspect of the present invention.

Anti-Microbial Nickel

Airborne filter media: nickel, nickel alloy, nickel-plated, or nickel-compound coated or embedded balls, pellets, orbs, or other three-dimensional shapes with a lightweight or hollow substrate that causes the nickel-coated filter media to become partially or fully airborne when subjected to airflow. Surface of the balls can be dimpled, roughed, smoothed, slitted, punctured, ribbed, skeletal, nubbed, spiked, or otherwise contoured.

Static or loose filter media: nickel, nickel alloy, nickel-plated, or nickel-compound coated or embedded balls, pellets, or other three dimensional shapes that remain all or mostly stationary when subjected to airflow. These nickel-compound coated or embedded balls can be electrically charged to promote particle contact. Surface of the balls can be dimpled, roughed, smoothed, slitted, punctured, ribbed, skeletal, nubbed, spiked, or otherwise contoured.

Nickel Surface Media Scrubber Filter

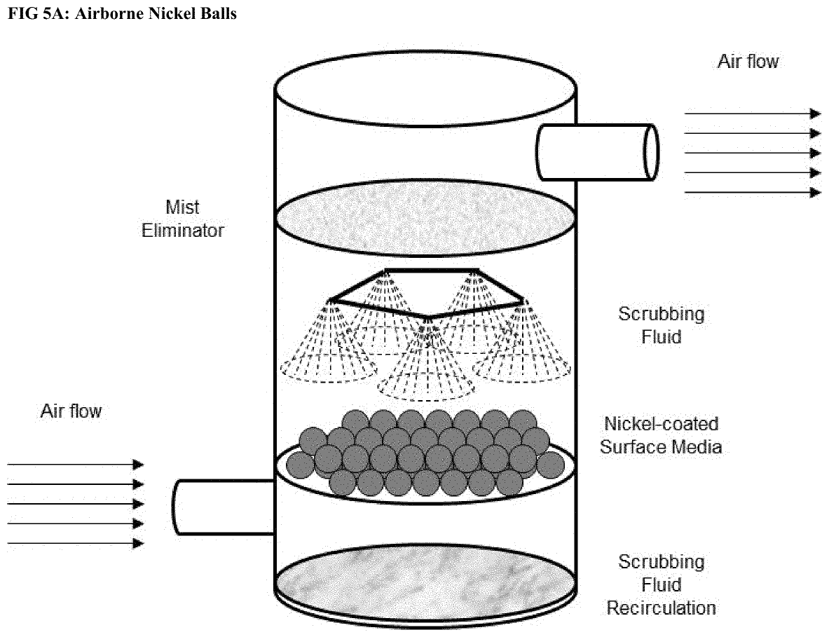

Shown in FIG. 5A is an exemplary embodiment of a nickel filter employing airborne nickel balls according to another aspect of the present invention.

Anti-Microbial Nickel

Fluid, such as air, is pumped through a packed nickel-coated surface media as a water-based or other scrubbing fluid is sprayed onto the nickel-coated media bed. A Nickel/nickel-alloy/nickel-based compound is coated or impregnated on the media bed for use in variety of scrubber designs.

Nickel-Activated Fiber Filters for Heating, Ventilation, Air Conditioning, Clean Room, and Other Air-Handling Use

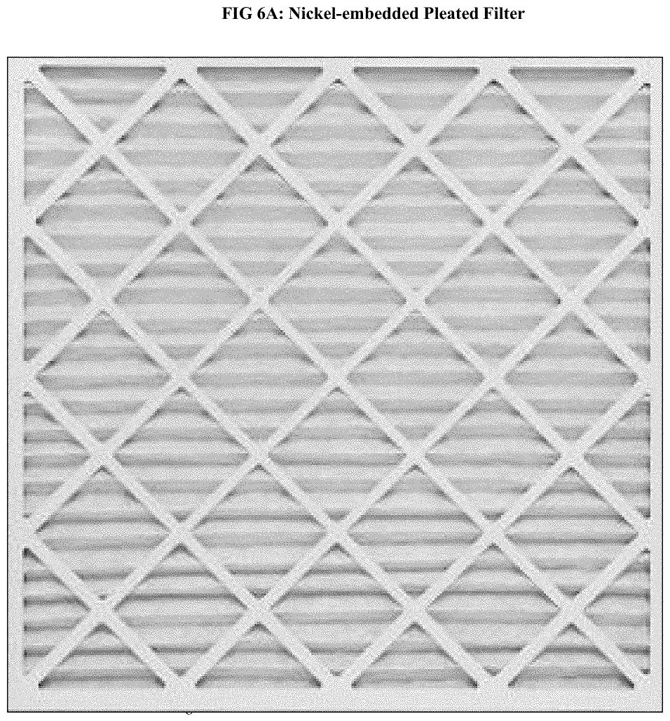

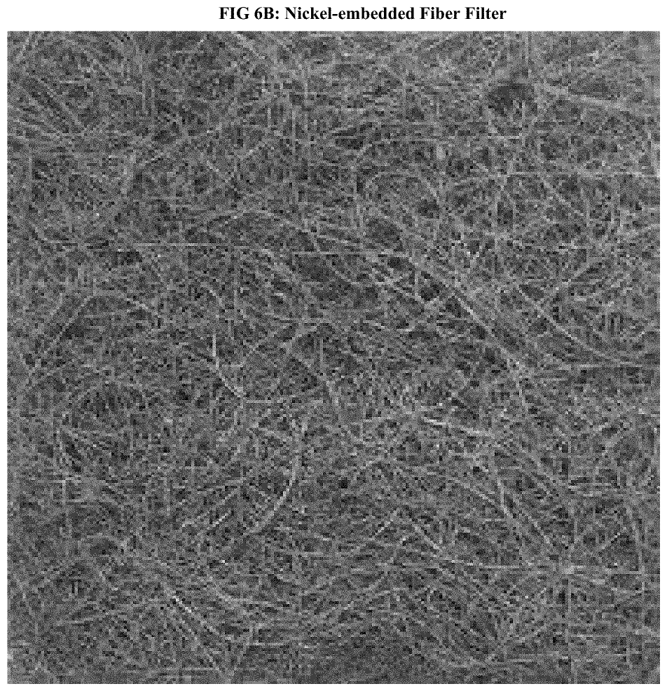

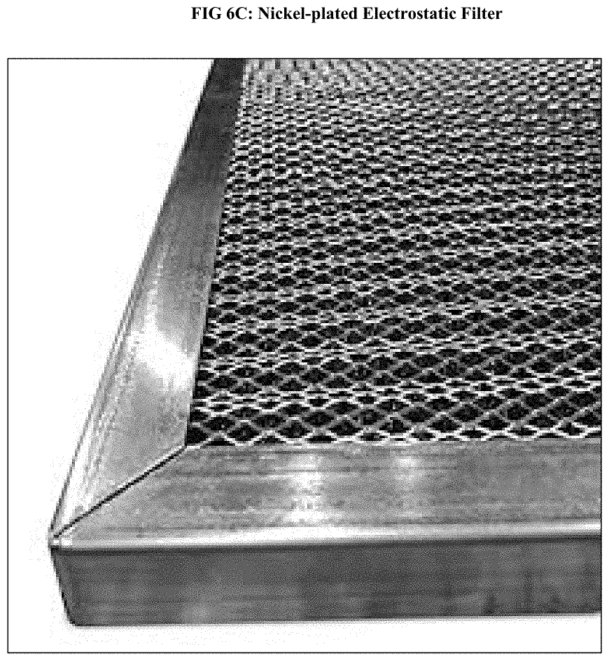

Shown in FIGS. 6A-B are exemplary embodiments of nickel-activated fiber filters according to another aspect of the present invention.

A filter and filter material is made from layers of wire or weave of nickel-based fiber (with varying cross-sectional shape, e.g. round, square, triangular, grooved, etc.) of nickel, nickel plated substrate (such as copper or brass), nickel alloy, nickel-based-compound coatings, such as nickel oxide, or particles or fibers thereof imbedded, impregnated, adhered, or intermixed with other material, such as nickel-based particles adhered to synthetic or natural fibers.

Extruded or spun nickel, nickel alloy, nickel plated, or nickel-coated fibers are woven into a fabric either entirely of nickel, nickel alloy, nickel plated, or nickel coated fibers. The nickel fibers can also be interwoven with other natural or synthetic fibers to improve overall fabric performance.

Nickel particles can also be coated in varying amounts to natural (e.g. cotton or wool) and synthetic (e.g. polyester, polypropylene, nylon, acrylic, fiberglass, rock wool, mineral wool, etc.) fibers, such that growth from microbes coming in contact with or in proximity to the nickel-based particles adhered to the fiber will be inhibited.

Nickel-based filter material can be formed into traditional HVAC filter designed filter jigs and frames (e.g. pleated filters, fiber filters, washable filter plates, electrostatic filters, HEPA filters, etc.). Shown in FIG. 6C is an exemplary embodiment of a nickel plated electrostatic filter according to another aspect of the present invention.

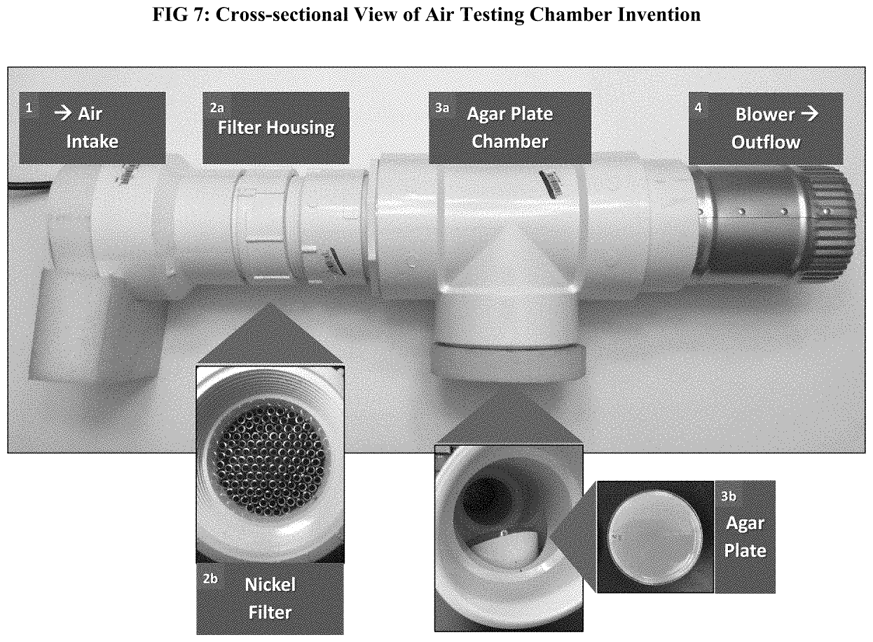

Turning to FIG. 7, shown therein is a prototype build-out of the circular tubular filter design further described in FIG. 1A. Three of these prototypes were built to pilot test the anti-pathogen effectiveness of nickel and copper. The prototype nickel tubular filter herein utilizes a blower to draw air through the filter media. The lengths, shape, diameter, etc. of the filter media can vary, as previously described, by changing out the filter housing segment of the test chamber (FIG. 7-2a). Multiple filter housings can be mounted in series, with different or the same filter media contained therein. After the ambient air is drawn through the enclosed chamber by the pressure differential, it is directed over an agar plate chamber for a specified time period to capture, culture, and measure bacteria concentrations. Multiple types of agar were tested, with tryptic soy preferred, due to its heightened sensitivity to culture trace amounts of bacteria contained in ambient air. This type of procedure enables a comparative analysis of microbe concentrations that pass through the test chamber, with or without filtration and through various configurations of filtration media. The air flow propulsion device/blower fan was positioned after filtration to minimize bacteria contamination of the blower and also because experimentation showed improved airflow by drawing the air through the filter versus pushing the air through.

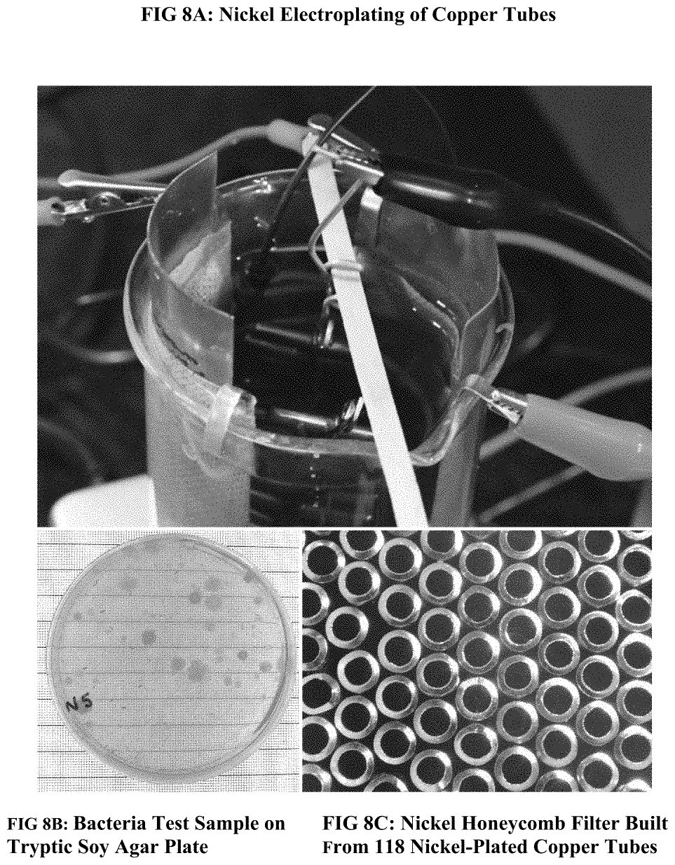

Turning to FIG. 8A, shown therein is a bench-scale nickel electroplating process incorporated to plate the copper tubes used as subcomponents in several embodiments of the present invention. Current was applied at a various current densities and for various lengths of time in order to obtain the desired thickness of nickel plating. A rectifier was used to regulate both voltage and current for the electroplating process. A special copper hanger jig was created for the purpose of plating the tubular sub-components of the nickel filter, with multiple-stage submersion and electroplating-fluid circulation required to ensure complete plating inside and outside each filter subcomponent.

Turning to FIG. 8B, shown therein is a test sample on a tryptic soy agar plate after a period of incubation to grow the bacteria. This illustrative culture sample of was taken from the prototype filtration device described in FIG. 7.

Turning to FIG. 8C, shown therein is a portion of the nickel honeycomb filter configuration of the Circular Tubular Filter Design further described in FIG. 1A. This figure shows tubes of copper substrate that have been plated with determined thicknesses of nickel. One of the prototype filter chambers used a configuration of 118 of these honeycomb-packed tubes.

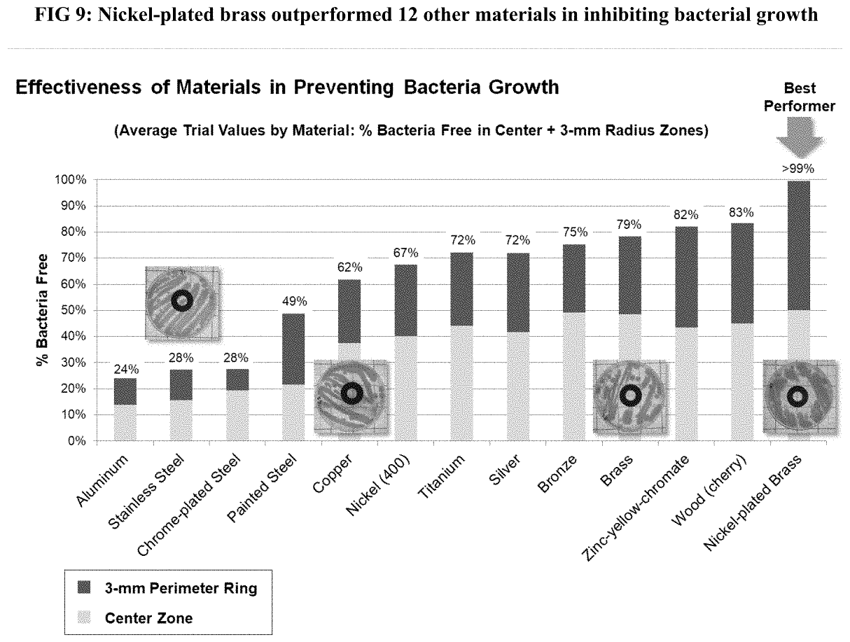

Turning to FIG. 9, shown therein is a chart showing nickel-plated brass outperformed twelve other materials in inhibiting E. coli bacterial growth on touch surfaces, which are the materials used on surfaces commonly touched by humans on a day-to-day basis-such as door handles, elevator buttons, handrails, etc. The chart also shows how the antibacterial properties of nickel are not only superior to other common surface materials in inhibiting bacteria growth in contact with the surface, but also within a 3 millimeter proximity to the surface. Consequently, the exemplary embodiments of the present invention utilize nickel to inhibit airborne bacteria, viruses, fungi, and other microbial pathogens.

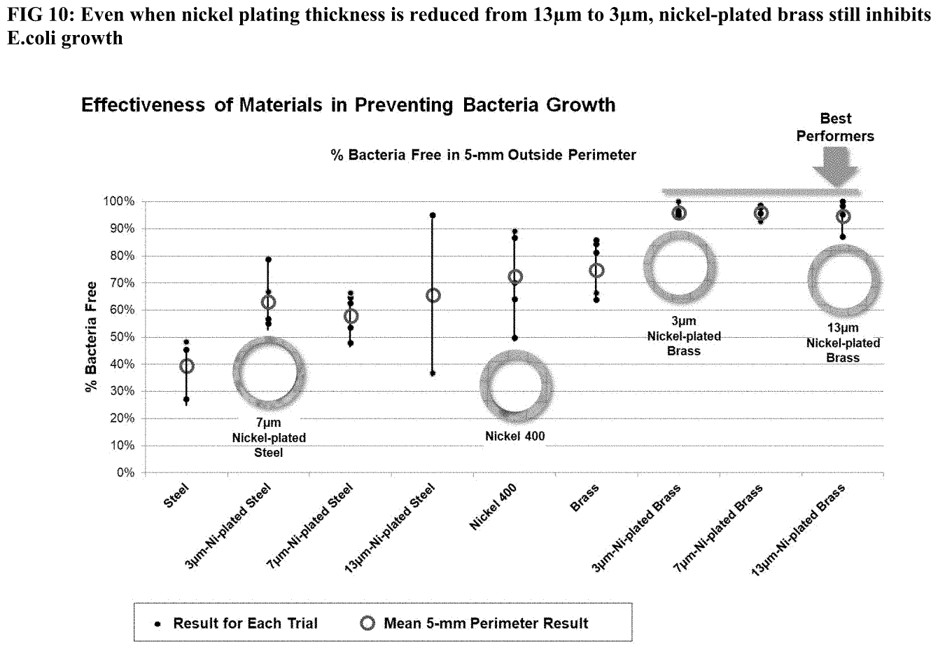

Turning to FIG. 10, shown therein is a chart showing that even when nickel plating thickness is reduced from 13 μm to 3 μm, nickel-plated brass still inhibits E. coli bacterial growth, thereby providing a specific nickel composition used in the exemplary embodiments of the present invention. Thus, nickel remains effective at inhibiting microbial growth with nickel plating thicknesses of less than 3 μm.

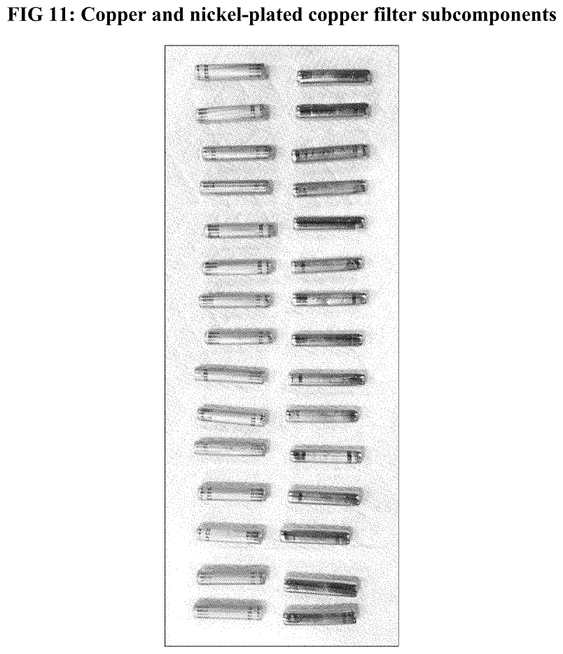

Turning to FIG. 11, shown therein are copper and nickel-plated copper filter subcomponents used in the exemplary prototype embodiment of the present invention found in FIG. 7.

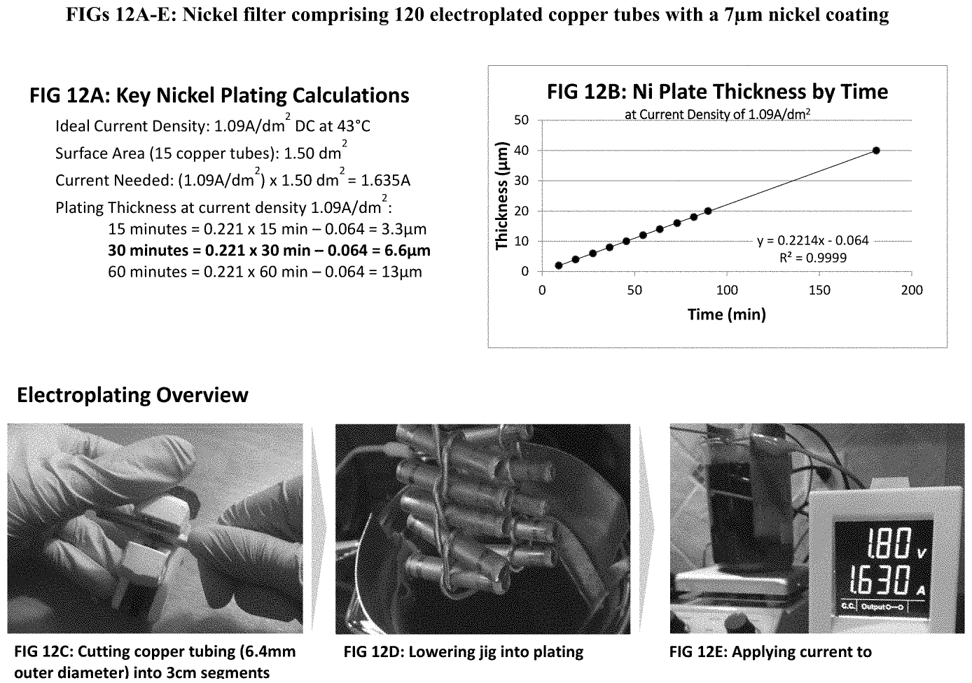

Turning to FIG. 12A, shown therein is an overview of nickel-plating calculations for current density and reaction time to achieve desired nickel plating thickness used in the nickel electroplating process of various embodiments of the present invention.

Turning to FIG. 12B, shown therein is a chart showing nickel plate thickness over time at a representative electroplating solution current density (1.09 A/dm²) for the nickel electroplating process of various embodiments of the present invention.

Turning to FIGS. 12C-E, shown therein are three stages of the electroplating process used in testing the embodiments of the present invention, including the cutting of copper substrate tubing, lowering of the electroplating jig into the nickel-ion solution, and a view of the rectifier used to control the voltage and current of the bench-scale electroplating process of various embodiments of the present invention.

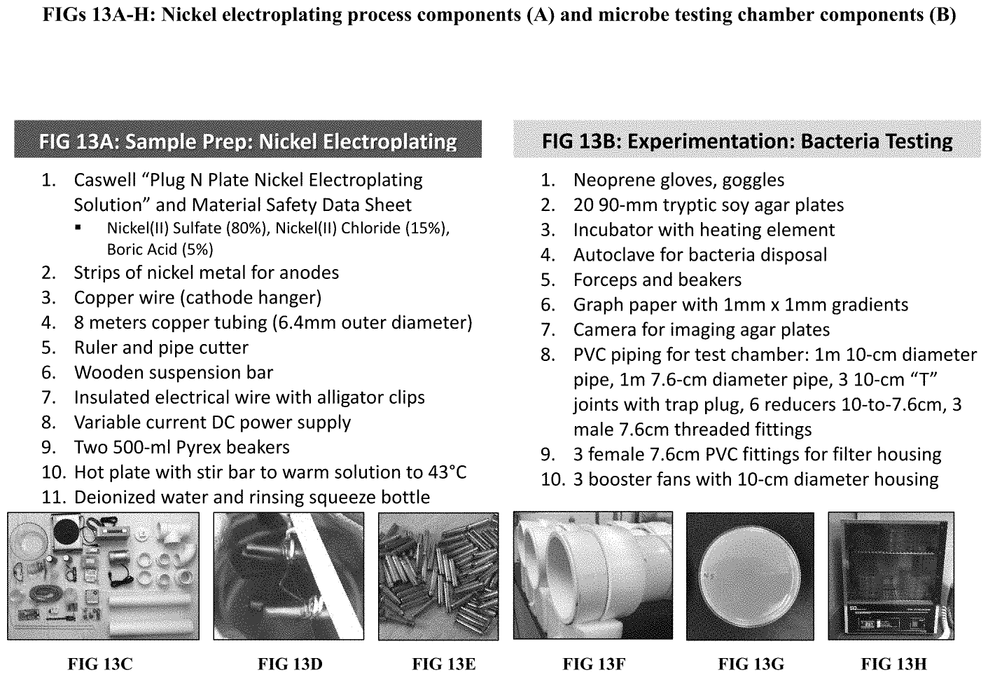

Turning to FIG. 13A, shown therein are nickel electroplating process components used in conducting experiments of the present invention.

Turning to FIG. 13B, shown therein are the microbe testing chamber components used in conducting experiments using a prototype of the present invention.

Turning to FIGS. 13C-H, shown therein are pictures of the components of FIGS. 13A-B.

Turning to FIG. 13C, shown therein is a layout of most of the parts utilized to build a prototype of various embodiments of the present invention.

Turning to FIG. 13D, shown therein is the bench-scale process developed for electroplating subcomponents of a prototype filter used in various embodiments of the present invention.

Turning to FIG. 13E, shown therein is a representation of copper and nickel filter subcomponents used in various embodiments of the present invention.

Turning to FIG. 13F, shown therein are the ambient-air intakes of three prototype filter test chambers used in various embodiments of the present invention.

Turning to FIG. 13G, shown therein is an illustrative agar plate used to measure bacteria concentrations within a prototype device used in various embodiments of this present invention.

Turning to FIG. 13H, shown therein is the incubation chamber used to culture bacteria from ambient air test samples.

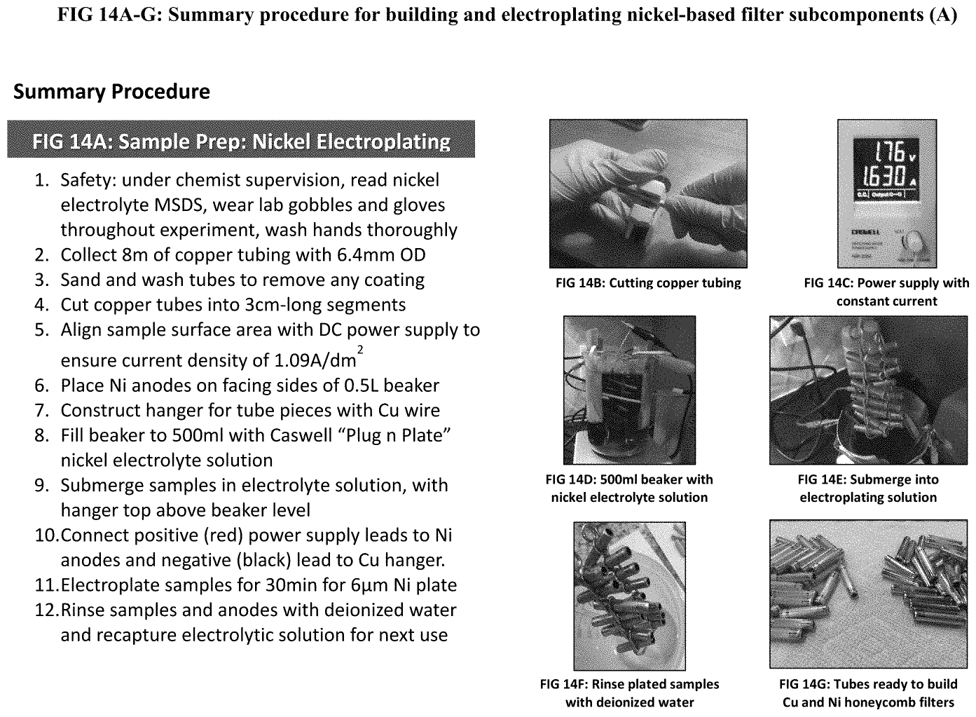

Turning to FIG. 14A, shown therein is the summary procedure for the nickel electroplating subcomponents of one embodiment of the present invention.

Turning to FIGS. 14B-G, shown therein are pictures of the nickel electroplating process of FIG. 14A.

Turning to FIG. 14B, shown therein is the process of cutting the copper tubing used to make the filter subcomponent substrate in a prototype device used in various embodiments of this present invention.

Turning to FIG. 14C, shown therein are illustrative voltage and current settings used to plate nickel onto filter subcomponents in various embodiments of this present invention.

Turning to FIG. 14D, shown therein is the bench-scale electroplating process used in various embodiments of this present invention.

Turning to FIG. 14E, shown therein are filter subcomponents prior to nickel electroplating used in various embodiments of this present invention.

Turning to FIG. 14F, shown therein are filter subcomponents after nickel electroplating used in various embodiments of this present invention.

Turning to FIG. 14G, shown therein are copper and nickel-plated subcomponents used to build the honeycomb filter used in various embodiments of this present invention.

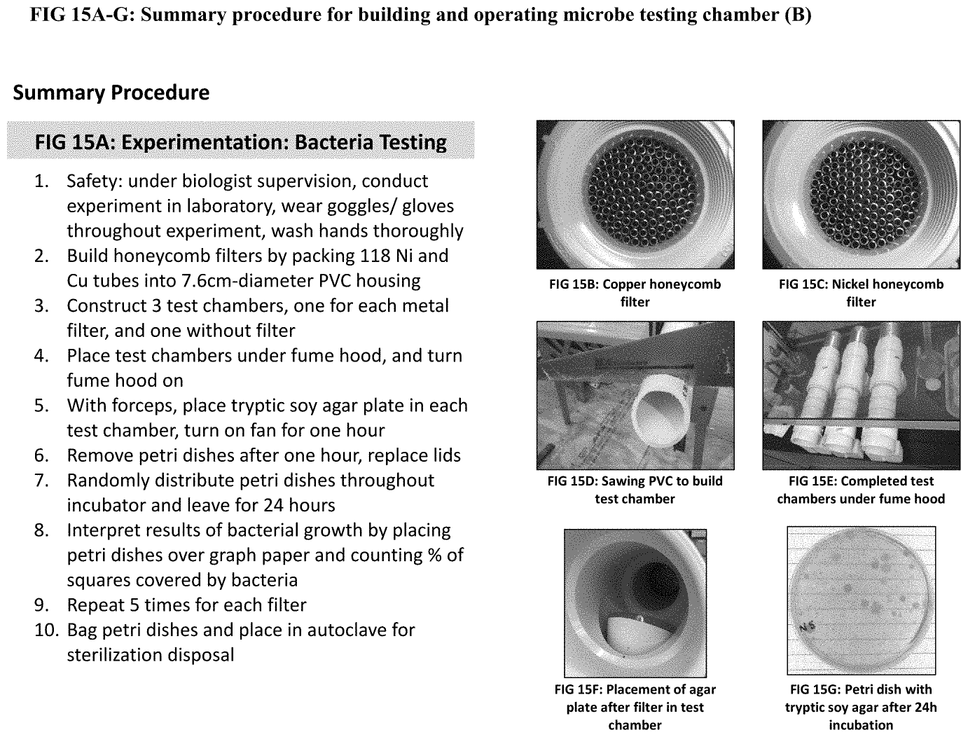

Turning to FIG. 15A, shown therein is the summary procedure for building and operating the microbe testing chamber for experiments used in the present invention.

Turning to FIGS. 15B-G, shown therein are pictures of the process of FIG. 15A.

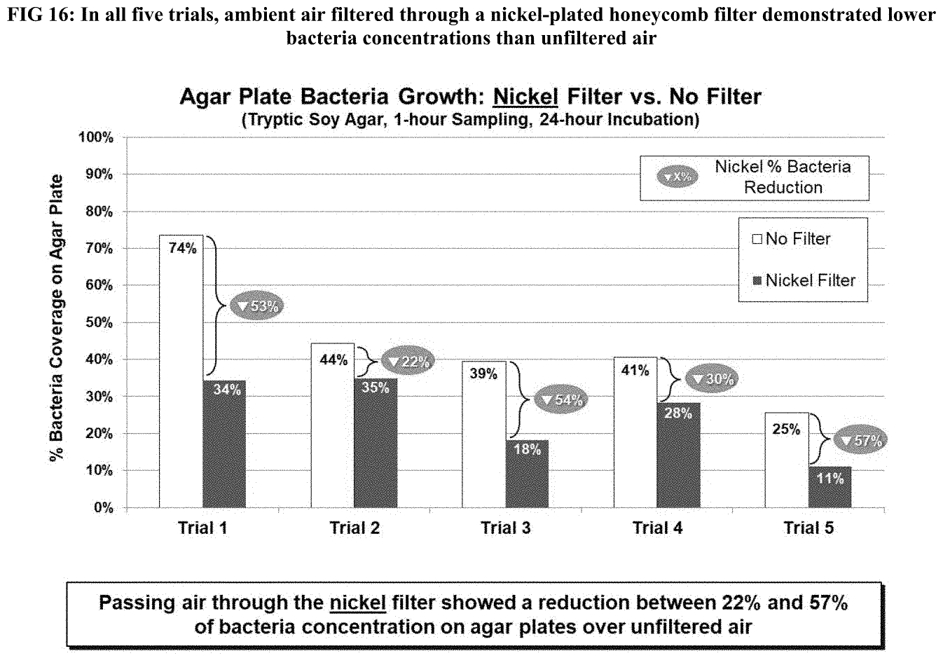

Turning to FIG. 16, shown therein is a chart of bacteria growth for an exemplary embodiment of a nickel filter of certain specifications versus no filter for five separate trials.

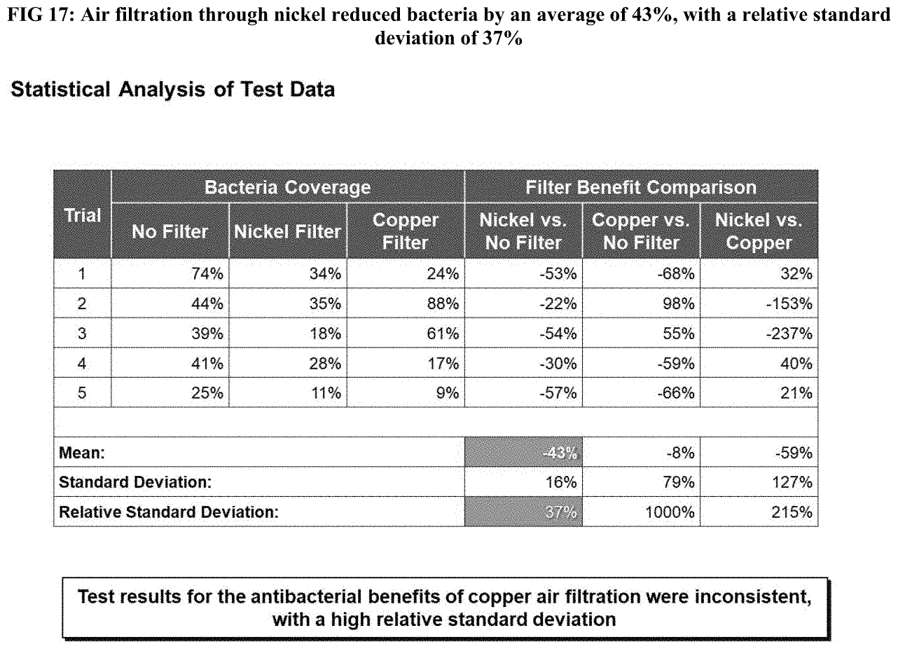

Turning to FIG. 17, shown therein is a chart of statistical analysis of test data from experiments of an exemplary embodiment of the present invention.

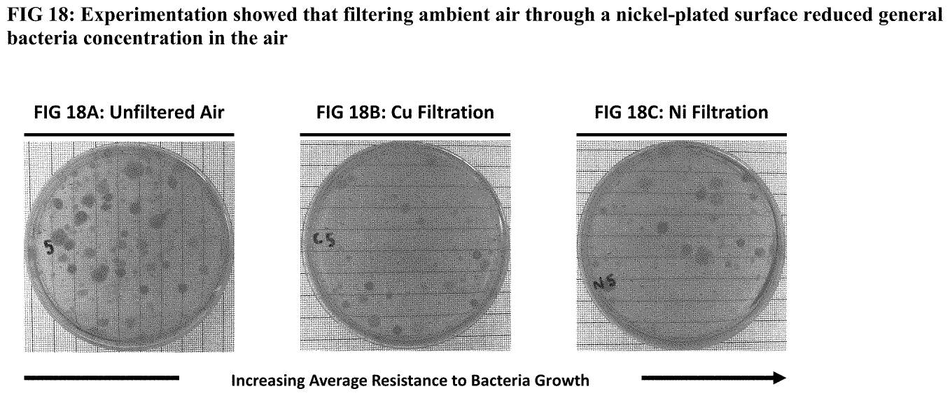

Turning to FIGS. 18A-C, shown therein are pictures of bacteria growth for unfiltered air, copper filtration, and nickel filtration, respectively, with each having increased average resistance to bacteria growth from experiments of an exemplary embodiment of the present invention.

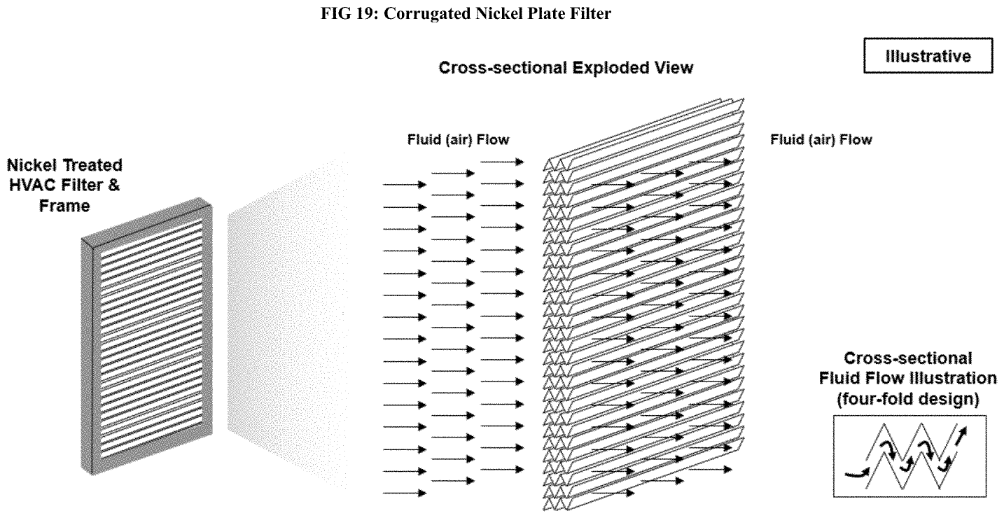

Turning to FIG. 19, shown there in another exemplary embodiment of a filter according to still another aspect of the present invention. The filter comprises an anti-microbial nickel filter constructed of nickel, nickel-plate, nickel alloy, or nickel compound (e.g., nickel oxide) arranged in a corrugated-like stacked alignment (with one fold or many folds), and fitted into a support frame for use in commercial, industrial, or residential HVAC applications. The corrugated-like nickel filter matrix may alternatively contain removable or washable physical filter media (such as hepa-filtration) packed between the corrugated layers or in series with the nickel-treated filter. In operation fluid flow (e.g., air) forces microbes to contact nickel-treated multi-fold corrugated surface in laminar or turbulent flow, thereby neutralizing microbes as they pass through the filter matrix.

The above description of the present invention is illustrative, and is not intended to be limiting. It will thus be appreciated that various additions, substitutions and modifications may be made to the above described embodiments without departing from the scope of the present invention. Accordingly, the scope of the present invention should be construed in reference to the appended claims.

It will also be appreciated that the various features set forth in the claims may be presented in various combinations and sub-combinations in future claims without departing from the scope of the invention. In particular, the present disclosure expressly contemplates any such combination or sub-combination that is not known to the prior art, as if such combinations or sub-combinations were expressly written out. By way of example, absent some teaching otherwise, it is expressly contemplated that any features disclosed in two or more dependent claims may be in the following claims listing may be combined together into the same claim without departing from the scope of the teachings herein.

What is claimed is:

1. An apparatus for filtering a fluid, including air, comprising:
a first plurality of longitudinal fluid conductors, each having an inner surface;
each of said inner and exposed surfaces of the longitudinal fluid conductors being coated or embedded with one or more of the following: nickel, a nickel alloy, a nickel-plated material, a nickel oxide material, a nickel compound, a nickel-plated brass material, and a combination thereof; and
each of said longitudinal fluid conductors each having a diameter between about 1 nanometer to about 10 centimeters, which can be arranged together to form larger composite sizes.

2. The apparatus according to claim 1, further comprising:
a second plurality of a longitudinal fluid conductors disposed downstream from the first plurality of longitudinal fluid conductors, each having an inner surface;
each of said inner and exposed surfaces of the longitudinal fluid conductors being coated or embedded with one or more of the following: nickel, a nickel alloy, a nickel-plated material, a nickel-plated brass material, a nickel oxide material, a nickel compound, and a combination thereof;
each of said longitudinal fluid conductors having a diameter between about 1 nanometer to about 10 centimeters, which can be arranged together to form larger composite sizes; and
a housing containing the first and second plurality of longitudinal conductors; and
each of said longitudinal fluid conductors having an electric charge to attract pathogen and pathogen-carrying particles to come in contact with the coated or embedded surfaces.

3. The apparatus according to claim 2, further comprising:
a fan drawing the fluid into the first plurality of longitudinal conductors and then into the second plurality of longitudinal conductors.

4. The apparatus according to claim 2, further comprising:
a fan blowing the fluid into the first plurality of longitudinal conductors and then into the second plurality of longitudinal conductors.

5. The apparatus according to claim 1, further comprising:
a pressure differential drawing the fluid out of the first plurality of longitudinal conductors.

6. A filter matrix comprising:
a plurality of surfaces composed of one of more of the following: nickel, a nickel alloy, a nickel-plated material, a nickel oxide material, a nickel compound, a nickel-plated brass material, and a combination thereof; and
a pressure differential drawing the air over the plurality of surfaces, whereby the interaction of the air and the plurality of surfaces inhibits growth of pathogens or microbes that come in contact or in proximity to the plurality of surfaces.

7. A method for filtering a fluid, such as air, comprising:
drawing the fluid through one or more filter stages, wherein each of the one or more filter stages has an input to receive the fluid and an output via which filtered fluid exits; and
drawing the fluid over a plurality of surfaces inside each of the one or more filter stages wherein each of the plurality of surfaces is comprised of one of more of the following: nickel, a nickel alloy, a nickel-plated material, a nickel-plated brass material, a nickel oxide material, a nickel compound, and a combination thereof.

8. The method according to claim 7, wherein each of the one or more filter stages comprises one or more tubes having a circular cross-section, and each of the inner and/or outer surfaces of the one or more tubes is comprised of one of more of the following: nickel, a nickel alloy, a nickel-plated material, a nickel-plated brass material, a nickel oxide material, a nickel compound, and a combination thereof.

9. The method according to claim 7, wherein each of the one or more filter stages comprises a plurality of tubes arranged in a honeycomb-like pattern, each of said plurality of tubes having a hexagonal cross-section, and each of the inner and/or outer surfaces of the plurality of tubes is comprised of one of more of the following: nickel, a nickel alloy, a nickel-plated material, a nickel-plated brass material, a nickel oxide material, a nickel compound, and a combination thereof.

10. The method according to claim 7, wherein each of the one or more filter stages comprises a plurality of tubes arranged in a honeycomb-like pattern, each of said plurality of tubes having a hexagonal or triangular cross-section, and each of the inner and/or outer surfaces of the plurality of tubes is comprised of one of more of the following: nickel, a nickel alloy, a nickel-plated material, a nickel-plated brass material, a nickel oxide material, a nickel compound, and a combination thereof.

11. The method according to claim 7, wherein each of the one or more filter stages comprises a maze structure, wherein the fluid is drawn through or forced to pass through multiple chambers inside the maze structure and thereby interact with a plurality of inner and/or outer surfaces inside the maze structure, and each of the plurality of inner and/or outer surfaces is comprised of one of more of the following: nickel, a nickel alloy, a nickel-plated material, a nickel-plated brass material, a nickel oxide material, a nickel compound, and a combination thereof.

12. The method according to claim 7, wherein each of the one or more filter stages comprises a radial baffle, wherein the fluid is drawn through or forced to pass through multiple chambers inside the radial baffle and thereby interact with a plurality of inner and/or outer surfaces inside the radial baffle, and each of the plurality of inner and/or outer surfaces is comprised of one of more of the following: nickel, a nickel alloy, a nickel-plated material, a nickel-plated brass material, a nickel oxide material, a nickel compound, and a combination thereof.

13. The method according to claim 7, wherein each of the one or more filter stages comprises a fiber filter having a plurality of treated fibers, wherein each of the treated fibers is treated with one or more of the following: nickel, a nickel alloy, a nickel-plated material, a nickel-plated brass material, a nickel oxide material, a nickel compound, and a combination thereof.

14. The method according to claim 7, wherein each of the one or more filter stages comprises a thread-based filter having a plurality of treated threads, wherein each of the treated threads is treated with one or more of the following: nickel, a nickel alloy, a nickel-plated material, a nickel-plated brass material, a nickel oxide material, a nickel compound, and a combination thereof.

15. The method according to claim 7, wherein each of the one or more filter stages comprises a wire-based filter having a plurality of treated wires, wherein each of the treated wires is treated with one or more of the following: nickel, a nickel alloy, a nickel-plated material, a nickel-plated brass material, a nickel oxide material, a nickel compound, and a combination thereof.

16. The method according to claim 15, wherein the treated wires are formed in a fibrous-like mesh.

17. The method according to claim 15, wherein each of the one or more filter stages are disposed in a circular tube, having an inner surface, and each of the one or more filter stages are formed in one or more concentric circles inside the circular tube coupled together by a plurality of radii joined at a center of the one or more concentric circles and projecting outward to the inner surface of the circular tube.

18. The method according to claim 17, wherein the inner surface of the circular tube is comprised of one or more of the following: nickel, a nickel alloy, a nickel-plated material, a nickel-plated brass material, a nickel oxide material, a nickel compound, and a combination thereof.

19. The method according to claim 15, wherein each of the one or more filter stages are disposed in a four-sided tube, said four-sided tube having an inner surface, and each of the one or more filter stages are formed as a plurality of wires attached to two sides of the four sides of the four-sided tube.

20. The method according to claim 19, wherein the inner surface of the four-sided tube is comprised of one or more of the following: nickel, a nickel alloy, a nickel-plated material, a nickel-plated brass material, a nickel oxide material, a nickel compound, and a combination thereof.

21. The method according to claim 7, wherein each of the one or more filter stages comprises a canister through which the fluid passes, said canister having a plurality of balls or other three-dimensional shapes disposed inside, wherein an outer surface of each of the plurality of the balls comprised of one or more of the following: nickel, a nickel alloy, a nickel-plated material, a nickel-plated brass material, a nickel oxide material, a nickel compound, and a combination thereof.

22. The method according to claim 21, wherein the balls or other three-dimensional shapes are lightly packed so that the balls become airborne when the fluid passes through the canister, and the balls or other three dimensional shapes may have an electric charge to attract pathogen and pathogen-carrying particles to come in contact with said balls or other three-dimensional shapes.

23. The method according to claim 21, wherein the balls are densely packed so that the balls or other three-dimensional shapes do not move or move loosely when the fluid passes through the canister.

24. The method according to claim 21, wherein the canister comprises an inner surface made of one or more of the following: nickel, a nickel alloy, a nickel-plated material, a nickel-plated brass material, a nickel oxide material, a nickel compound, and a combination thereof.

25. The method according to claim 7, wherein each of the one or more filter stages comprises a metal embedded pleated filter, wherein the metal comprises one or more of the following: nickel, a nickel alloy, a nickel-plated material, a nickel-plated brass material, a nickel oxide material, a nickel compound, and a combination thereof.

26. The method according to claim 7, wherein each of the one or more filter stages comprises a metal embedded fiber filter, wherein the metal comprises one or more of the following: nickel, a nickel alloy, a nickel-plated material, a nickel-plated brass material, a nickel oxide material, a nickel compound, and a combination thereof.

27. The method according to claim 7, wherein each of the one or more filter stages comprises a metal plated electrostatic filter, wherein the metal comprises one or more of the following: nickel, a nickel alloy, a nickel-plated material, a nickel-plated brass material, a nickel oxide material, a nickel compound, and a combination thereof.

28. An apparatus for filtering a fluid comprising:
an enclosed canister having a top and a bottom;
a fluid input disposed at the bottom of the canister to receive the fluid to be filtered;
a fluid output disposed at a top of the canister to output the filtered fluid;
a scrubbing fluid recirculation section to receive the fluid from air input and disposed at the bottom of the canister;
a plate disposed above the scrubbing fluid recirculation section;
a plurality of metal coated surface media disposed on the plate;
a plurality of scrubbing fluid dispensers disposed above the plate and dispensing scrubbing fluid onto the plurality of metal coated surface media; and
a mist eliminator disposed above the scrubbing fluid dispensers and below the fluid output, wherein the metal comprises one or more of the following: nickel, a nickel alloy, a nickel-plated material, a nickel-plated brass material, a nickel oxide material, a nickel compound, and a combination thereof.

29. An apparatus for filtering pathogens comprising:
a plurality of surfaces composed of at least one material selected from the group consisting of: nickel, a nickel alloy, a nickel-plated material, a nickel-plated brass material, a nickel oxide material, a nickel compound, bronze, brass, and cherry wood; and
a pressure differential drawing the air over the plurality of surfaces, whereby the interaction of the air and the plurality of surfaces inhibits growth of pathogens that come in contact or in proximity to the plurality of surfaces.

30. The apparatus according to claim 29, wherein pathogens includes at least one selected from the group consisting of: microbes, microorganisms, bacteria, fungi, viruses and parasites.

31. The apparatus according to claim 29, wherein each of the plurality of surfaces has an electric charge to attract pathogen and pathogen-carrying particles to come in contact said each of the plurality of surfaces.
